(19) United States
(12) Patent Application Publication
(10) Pub. No.: US 2024/0289305 A1
(43) Pub. Date: Aug. 29, 2024

(54) ACCESSING AND TRANSFORMING MESSAGES IN AN ENTERPRISE INTEGRATION SYSTEM

(71) Applicant: MICROSOFT TECHNOLOGY LICENSING, LLC., REDMOND, WA (US)

(72) Inventors: PARIKSHIT KUMAR GUPTA, BOTHELL, WA (US); SANJIV GUPTA, RENTON, WA (US)

(21) Appl. No.: 18/113,455

(22) Filed: Feb. 23, 2023

(51) Int. Cl. G06F 16/21; G06F 9/54

(52) U.S. Cl. CPC G06F 16/211; G06F 9/546; G06F 2209/547

(57) ABSTRACT

A message transformation program consisting of key-value pairs that represent executable instructions is used to transform data exchanged in messages having different message formats and schemas between two enterprises with an enterprise integration system. The message transformation program is written in a programming language having program constructs that enable a developer to generate a message transformation program to transform data between disparate message formats and schemas regardless of the message format and schema used in a message.

### BACKGROUND

An enterprise integration system consists of independent applications that execute autonomously on disparate computing systems to work together to perform tasks of a workflow. A workflow consists of a sequence of tasks that are executed by the applications of the disparate computing systems of various enterprises in a loosely-coupled manner. The disparate systems are integrated through the use of asynchronous messaging in order to share data, applications, processes, devices and services needed to perform the tasks of the workflow.

An asynchronous message output by a source application may contain data configured in a message format and schema that may differ from the message format and schema expected by the message's recipient. The outgoing message from the source application often needs to be transformed into a message format and schema that is recognized by the message's recipient.

Extensible Stylesheet Language Transformations (XSLT) is a transformation programming language for transforming Extensive Markup Language (XML) documents from one XML schema into another XML schema. However, XSLT is a complex language that requires mastery of the XSLT language and programming skills to perform a simple transformation and is limited to transformations from one XML schema to another XML schema.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A message transformation program consisting of key-value pairs that represent executable instructions is used to transform data exchanged in messages between two enterprises within an enterprise integration system. The message transformation program is written in a programming language having program constructs that enable a developer to generate a message transformation program that transforms data in an outgoing message of a source application into an incoming message of a target application where both messages may have different message formats and schemas.

The message transformation program includes instructions in the form of the key-value pairs. A key-value pair includes a key that represents a node of a target schema. Its corresponding value represents a mapping of the data from the outgoing message into a target node of the target schema. The value or mapping may include a selector or source message path, an expression, a constant, or nested key-value pairs. An expression is a combination of constants, functions, indices, filters, and/or selectors that produce a result, such as a string, number, Boolean, or null/nil output.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary enterprise integration system utilizing a message transformation engine.

FIGS. 2A-2C is a schematic diagram illustrating an exemplary transformation program.

FIG. 3 illustrates an exemplary transformation having executable instructions for a direct translation.

FIG. 4 illustrates an exemplary transformation having executable instructions for a data translation.

FIG. 5 illustrates an exemplary transformation having executable instructions for a cumulative expression.

FIG. 6 illustrates an exemplary transformation having executable instructions for a conditional mapping.

FIG. 7 illustrates an exemplary transformation having executable instructions for iterating through a loop.

FIG. 8 illustrates an exemplary transformation having executable instructions for iterating through a loop based on a condition.

FIG. 9 illustrates an exemplary transformation having executable instructions for iterating through a loop based on an index.

FIG. 10 is a flow diagram illustrating an exemplary method of performing transformations.

FIG. 11 is a block diagram illustrating an exemplary operating environment.

### DETAILED DESCRIPTION

### Overview

Aspects of the present disclosure pertain to the transformation of messages having data in disparate message formats and schemas in an enterprise integration system. An enterprise integration system consists of various independent applications that communicate through asynchronous messages. An asynchronous message includes a payload having data structured in a particular message format and schema. A source application may output a message in a particular message format and schema which is destined to a target application that only recognizes data in a particular message format and schema. A message transformation program is utilized to transform the message into the message format and schema understood by the target application.

The message transformation program is written in a programming language that consists of instructions configured as key-value pairs. The key-value pairs are structured in an order and hierarchy that matches the structure of the target schema with instructions on how to extract the data from the outgoing message. The message transformation program is compiled into executable code that is executed by a message transformation engine.

The message transformation engine takes a message transformation program and incoming message as input. The incoming message must comply with the schema referenced in the message transformation program. The message transformation engine does that validation. The message transformation engine parses the message transformation program into memory and iterates over the key-value pairs defined in the program. The message transformation program extracts the value part from the incoming message and creates an output node of the target schema. When all key-value pairs are processed, the hierarchical collection of output nodes is returned as a new message.

A key-value pair includes a key that represents a node of the target schema or a control flow statement. Its corresponding value represents the mapping of the data from the source message into the target node. The value or mapping may include a selector, an expression, a constant, or a complex value. An expression is a combination of constants, functions, selectors, indices, and/or filters, that produce a result, such as a string, number, or Boolean ($true, $false), null/nil output.

A complex value includes one or more nested key-value pairs. A constant includes a number, string, Boolean or null value ($null or $nil). A selector is the path to the source message containing data to extract and input into a target node. The selector is message format agnostic. A selector may contain a namespace prefix depending on name requirement set in the source schema. A filter can be applied to a collection in the source message to extract a specific node value or a collection of values using the square brackets, [ ]. Context inside the square brackets can be a number to specify a certain element index in a collection or sequence or an expression that specifies condition for targeting specific subset of incoming message.

Attention now turns to a more detailed description of the system and methods of the message transformation.

### System

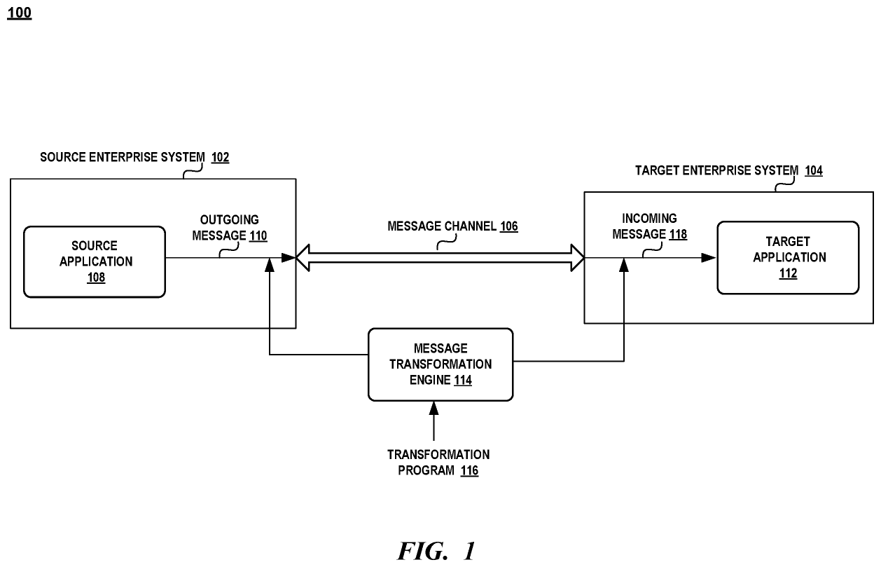

FIG. 1 illustrates a block diagram of an exemplary enterprise integration system 100. The system 100 may include a source enterprise system 102 communicatively coupled to a target enterprise system 104 through a message channel 106. A message channel is a point-to-point connection where only one receiver receives a message.

The source enterprise system 102 includes a source application 108 that generates an output message 110 destined to a target application 112 of a target enterprise system 104. A message transformation engine 114 executes a message transformation program 116 that transforms the output message 110 into the message format and schema of the target application 112.

In an aspect, the source application 108 and the target application 112 are distributed applications that execute independently. The source application 108 communicates with the target application 112 through asynchronous messages. An asynchronous message is placed in a message channel or queue 106 and the sender of the message does not wait for a response to continue processing.

In an aspect, the message transformation engine 114 may be embedded in the source enterprise system 102 in order to transform the output message 110 into an input message 118 that adheres to the schema of the target application 112 before it is transmitted to the target application 112. In another aspect, the message transformation engine 114 may be embedded in the target enterprise system 104 in order to transform the output message 110 before the output message is received by the target application 112.

The output message 110 consists of a header and a payload. The header contains routing information, such as the destination address and the identity of the sender. The payload is formatted in accordance with a particular schema. A schema describes the structure and data type of the data of a message. Examples of message formats include Extensible Markup Language (XML) and the JavaScript Object Notation (JSON). XML is a markup language that describes a data or message format. The XML schema describes the structure and data types of the elements of an XML document. JSON is also a data or message format. A JSON schema describes the structure and data types of the data within the JSON data format.

Attention now turns to a more detailed description of the message transformation program of an enterprise integration system.

### Transformations

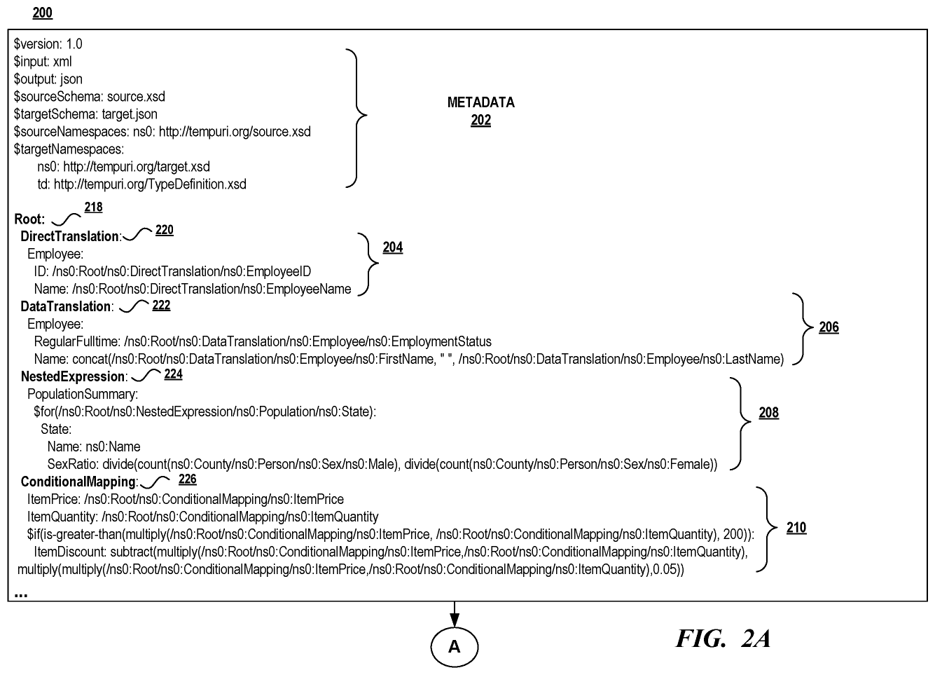

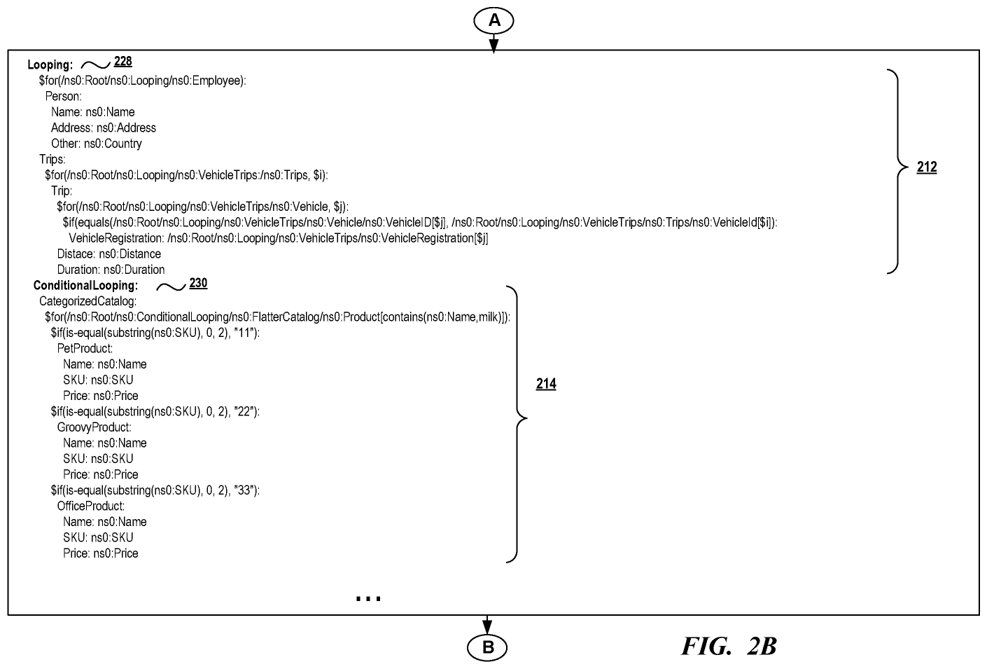

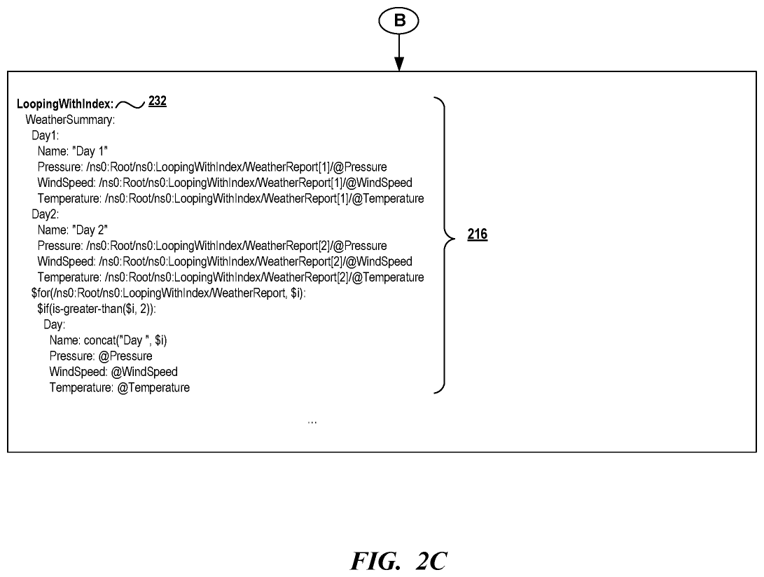

FIGS. 2A-2C illustrate an exemplary message transformation program 200 that transforms XML-formatted data of a source message structured in accordance with a source schema into a message of JSON-formatted data structured in accordance with a target schema. It should be noted that the examples shown in FIGS. 2A-2C are used to illustrate the program constructs of the transformation language and should not be construed as limiting the invention to only these types of transformations or program constructs. Appendix A lists the functions that may be used in a message transformation program and Appendix B represents the grammar of the transformation language used to generate a message transformation program.

Referring to FIG. 2A, the program 200 includes a metadata section 202 and a code section 204-216. The metadata section 202 describes the message transformation language version ($version:1.0), the source data format ($input: xml), the target data format ($output: json), the source schema ($sourceSchema: source.xsd), the target schema ($targetSchema: target.json), the source namespaces($sourceNamespaces: ns0:http://tempuri.org/source.xsd), and the target namespaces ($targetNamespaces:ns0:nttp://tempura.org/target.xsd, td: http://tempuri.org/TypeDefinition.xsd).

A namespace is a declarative region that provides a scope to the identifiers, types, functions, variables, etc. inside a message in order to prevent name collisions. The code section 204-216 follows the metadata section in the program and spans FIGS. 2A-2C. The metadata section 202 is used in the compilation of a message transformation program to generate executable code.

The code section 204-216 includes the key-value paired instructions that are executed to perform each transformation. The transformations are performed in the order that the key-value pairs appear in the program. The key-value pairs are structured in a hierarchical order that matches the target schema. The initial key-value pair consists of the key “Root:” whose associated value consists of a complex value that includes all the code shown below Root in FIG. 2A, all of the code shown in FIG. 2B, and all of the code shown in FIG. 2C.

A schema represents the structure of a class of a message where the structure includes the hierarchical ordering of the data and the data types associated with the class. Each message whose data adheres to the class's schema is an instance of the schema where the message structure is the same but the data content may differ. For example, an XML Schema Definition (XSD) file defines the structure of a specific XML message format or class and all instances of this class follow the same structure with different data content. A JSON schema defines the message structure for a JSON message of a specific class and all instances of the schema for this class will have the same structure and different data content.

Each schema represents the hierarchical ordering of data which starts with a single root. The hierarchical order is represented by the different levels within a schema. A level is represented by an indentation of an element within the program where the indented element is recognized as having a relationship to a previous level. The root is the highest level and the parent of all other levels that directly descend from the root level. A parent level is a level that contains child levels that depend from it.

Every level of a schema is considered a node. The root level is the root node. The values that contain a string, array, Boolean, null/nill, or number are considered the leaf nodes.

A key-value pair is an instruction that consists of a key and an associated value. The key contains a statement or a non-leaf node of the output schema followed by a colon character “:”. A statement is a stand-alone unit of execution that does not generate a value. In one aspect, the statements are conditional flow statements that control branches and loops, such as an “$if” statement” and a “$for” statement. The “$if statement” controls execution of a set of key-value pairs based on a condition being satisfied and the “$for statement” controls the iteration or repeated execution of a set of key-value paired instructions (i.e., loop).

A value represents an expression, a selector, a function, a constant, or a complex value. An expression is a combination of constants, functions, filter, indices and/or selectors that produce a result, such as a string, number, Boolean, null/nil output. A complex value includes one or more nested key-value pairs.

Referring to FIGS. 2A-2C, the transformation code has a root node, “Root”, 218, and several child nodes, “DirectTranslation,” 220, “DataTranslation,” 222, “NestedExpression,” 224, “Conditional Mapping,” 226, “Looping,” 228, “Conditional Looping,” 230, and “LoopingWithIndex” 232. Each of these child nodes are keys and their corresponding values are either a complex value, an expression, a constant, or a selector to the data in the source message. The transformations or mappings of each of the key-value pairs shown in FIGS. 2A-2C are explained in further detail below.

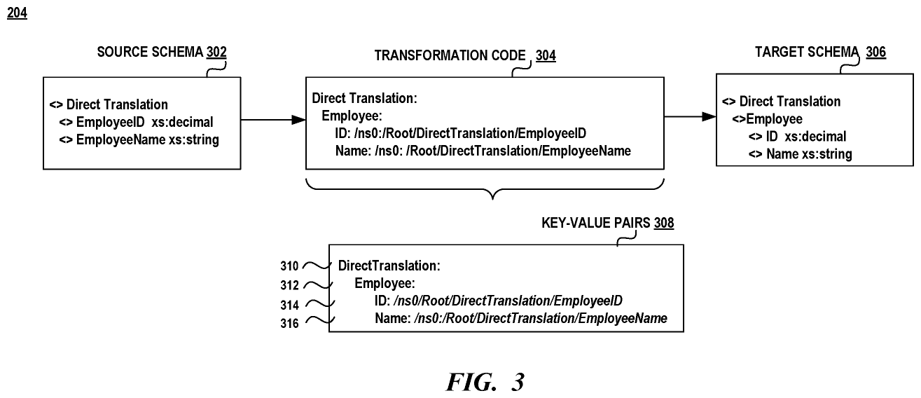

FIG. 3 shows an exemplary transformation 204 of a source schema 302 that can be directly transformed into a target schema 306 using transformation code 304.

The transformation code 304 includes the key “Direct Translation” 310 and its associated value is a complex value that consists of nested key-value pairs 312-316. Each nested key-value pair is indented in the schema to show its relationship with a respective parent key. The complex value 312-316 includes the key “Employee”, 312, with its corresponding value being another complex value 314-316 that includes two child key-value pairs. The child key-value pairs are positioned on the same level since they are siblings of each other. The first child key-value pair 314 consists of the key “ID”, which corresponds to the targetNodeName in the language's grammar, as shown in Appendix B, and its associated pair is “ns0/Root/DirectTranslation/EmployeeID” which is the selector to the data value (i.e., string) from the source message. The second child key-value pair 316 consists of the key “Name” and its associated pair is “ns0/Root/DirectTranslation/ns0:EmployeeName” which is the selector of the data value from the source message, EmployeeName, which corresponds to the qualifiedNodeName in the language's grammar shown in Appendix B.

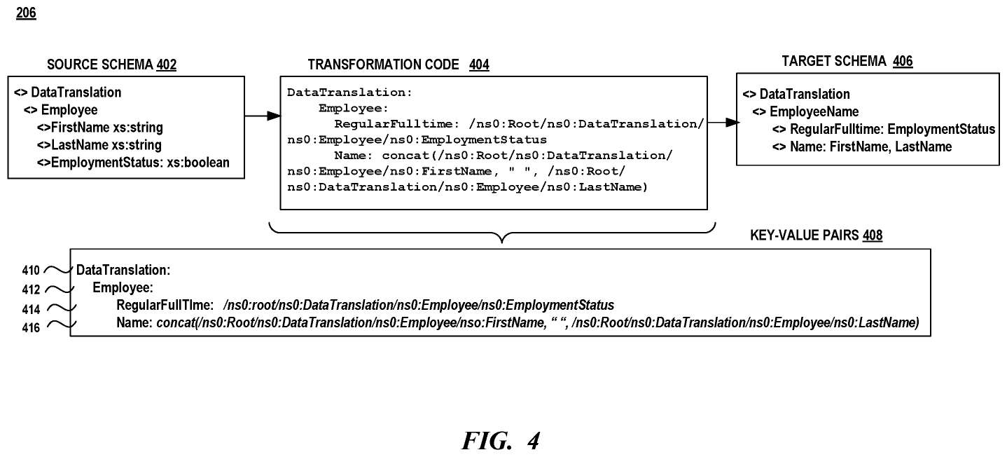

FIG. 4 illustrates an exemplary transformation 206 of a source schema 402 that is transformed into a target schema 406 using transformation code 408. This transformation uses an expression as a value to construct the data from the source message into the desired format of the target schema. The expression uses the concatenation function to generate the data from different nodes of the source message.

The transformation code 408 matches the target schema 406. The key-value pairs 408 include the key “DataTranslation:”, 410, and its associated value 412-416 is a complex value that contains a nested key-value pair. The complex value 412-416 includes the key “Employee” 412 and its associated value 414-416 includes another complex value that includes two child key-value pairs. The first child key-value pair 414 includes the key “RegularFullTime:” and its corresponding value is the selector, “/ns0:Root/ns0:Data Translation/ns0:Employee/ns0:EmploymentStatus.”

The second child key-value pair 416 has the key “Name:” which corresponds to the leaf target node in the grammar with its value as a function. The corresponding value is an expression. The expression is “concat (/ns0:Root/ns0:Data Translation/ns0:Employee/ns0:FirstName, ““, /ns0:Root/ns0:Data Translation/ns0:Employment/ns0:LastName.” The expression uses a concatenation function, concat( ) to combine the first name, a blank space and the last name. The concatenation function includes the selector to the first name and the last name in the source message to form a string consisting of the first name, blank space, and last name.

Various functions can be used in an expression in addition to the concatenation function. Appendix A lists the functions that may be used in the key-value pairs.

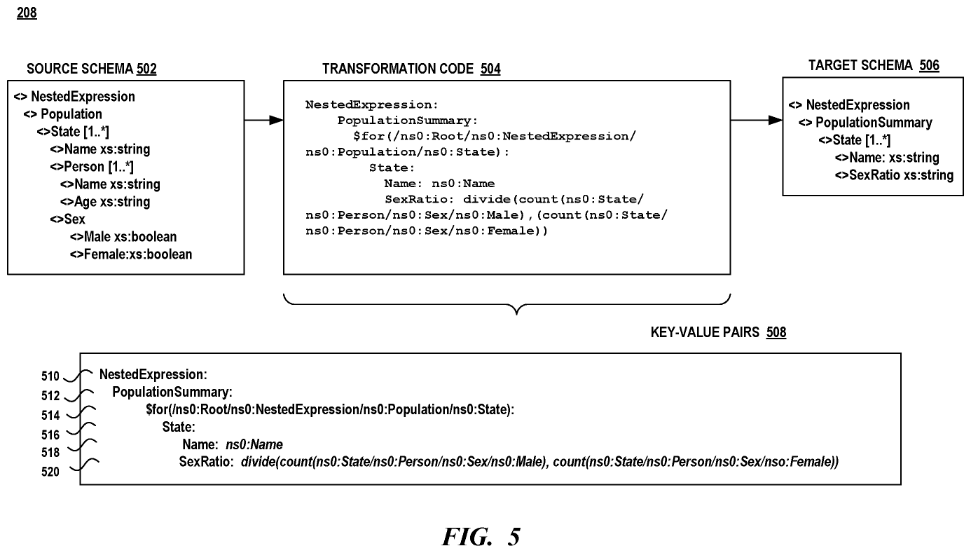

FIG. 5 illustrates an exemplary transformation 208 of a source schema 502 that is transformed into a target schema 506 using transformation code 504. In this transformation, a key of a key value pair includes a “$for statement” (i.e., for statement) that is used to iterate or loop through the complex value associated with the expression. The associated complex value represents the body of the loop controlled by the “$for statement.” This transformation is an example of a nested expression where one expression contains another expression, such as the divide expression using two count functions to compute counts within specific nodes of the source message.

The transformation code 504 includes the key “NestedExpression:” 510 and its corresponding value is a complex value 512-520 that includes nested key-value pairs. The complex value includes the key “PopulationSummary:”, 512, and its corresponding value is another complex value 514-520. The complex value of lines 514-520 includes a “$for statement” as its key which iterates lines 516 through line 520 for each State element contained in the State array of the source message. The corresponding value is another complex value that includes lines 516-520 which includes the key “Population Summary”. Its value is the complex value of lines 518-520 which includes a key-value pair at line 518 and a key-value pair at line 520. The key-value pair at line 518 includes the key “Name:” and its corresponding value is the selector to the data in the Name node in the source message, “ns0:Name.” The selector “ns0:Name” is an example of a relative selector. A relative selector is based on the selector specified in the $for statement and is combined with the selector specified in the $for statement to generate the full path to the source message value.

The key-value pair at line 520 contains the key “SexRatio” and the corresponding value is an expression that computes the ratio of the number of men in a specific state over the number of women in the state. This expression is a nested expression where a divide function includes two nested count functions, where a first count function counts the number of men in a specific state and a second count function counts the number of women in a specific state. The divide function computes the ratio of the two counts.

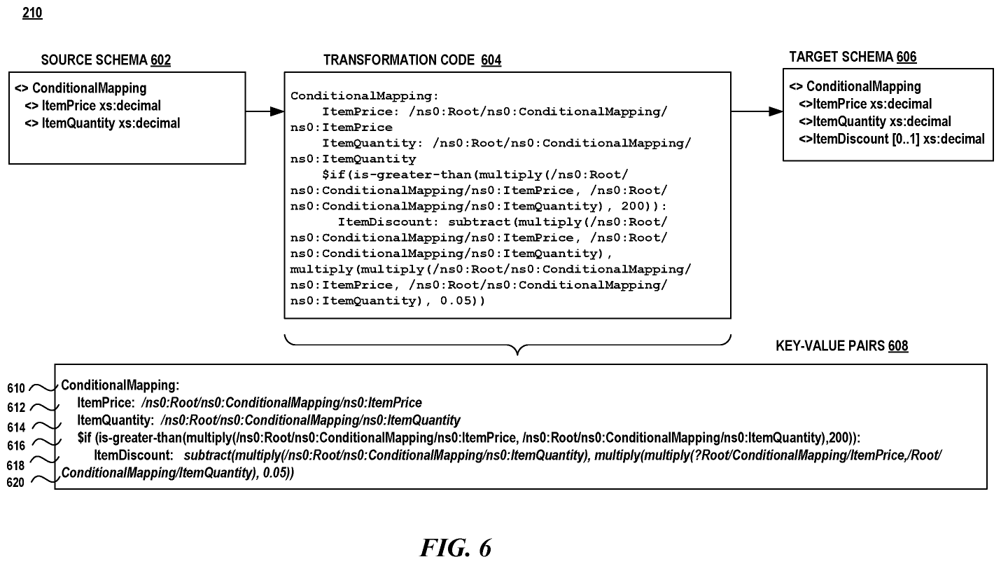

FIG. 6 illustrates an exemplary transformation 210 of a source schema 602 that is transformed into a target schema 606 using transformation code 604 which determines whether to generate a node in the transformed message based on a condition. In this transformation, a key of a key value pair includes a “$if statement” (i.e., if statement) that is used to control the execution flow through the complex value associated with the “$if statement”. The associated complex value represents the body of code controlled by the “$if statement.” This transformation is an example of a conditional mapping where one or more key-value pairs are executed based on the condition indicated in the “$if statement.”

The transformation code 604 includes the key “ConditionalMapping:” 610 and its corresponding value is a complex value 612-620 that includes nested key-value pairs. The complex value 612-620 includes the key-value pair 612, the key-value pair 614, and the key-value pair 616-620. The key-value pair 612 includes the key “ItemPrice” and its corresponding value is the selector, “/ns0:Root//ns0:ConditionalMapping/ns0:ItemPrice.” The key-value pair 614 includes the key “ItemQuantity” and its value is the selector, “/ns0:Root/ns0:ConditionalMapping/ns0:ItemQuantity.” The key-value pair 616-620 contains the “$if statement” shown in line 616 as a key and its associated value is the key-value pair of lines 618-620 where “ItemDiscount” is the key and the value is an expression. The “$if statement” contains an “is-greater-then” function with the function expression “multiply(/ns0:Root/ns0:ConditionalMapping/ns0:ItemPrice,/ns0:Root/ns0:ConditionalMapping/ns): ItemQuality, 200), where multiply is the functionName in the language's grammar, and multiply(/ns0:Root/ns0:ConditionalMapping/ns0:ItemPrice) is a parameter.

The expression 618 uses the subtract function and multiply function to compute an ItemDiscount value using the data of the source message. ItemDiscount is the leaf target node in the language's grammar with an expression as its value.

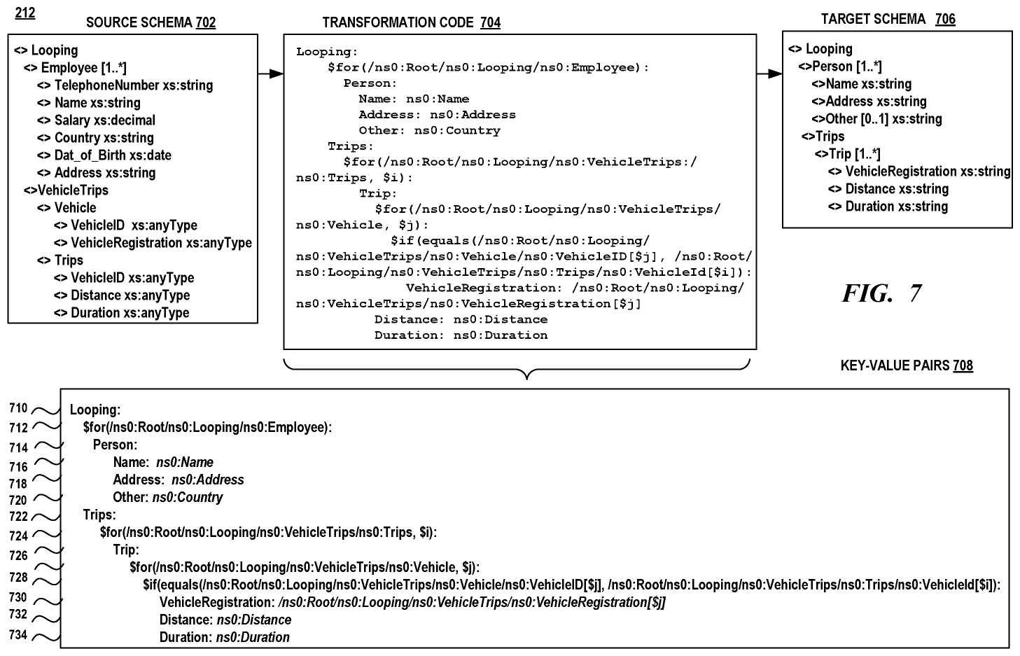

FIG. 7 illustrates an exemplary transformation 212 of a source schema 702 that is transformed into a target schema 706 using transformation code 704 to generate a repeating structure in the transformed message for each iteration of a loop. In this transformation, a key of a key-value pair includes a “$for statement” (i.e., for statement) that is used to iterate through an array of data from the source message.

The transformation code 704 includes the key “Looping:” 710 and its corresponding value is a complex value including lines 712-734 that includes several nested key-value pairs. The complex value 712-734 includes the key-value pair 712-720 and the key-value pair 722-734. The key-value pair 712-720 includes a for statement 712 as its key and its value is the complex value shown in lines 714-720. The for statement, “$for(/ns0:Root/ns0:Looping/ns0:Employee):” controls the iteration of lines 714-720 for each entry in the Employee array of the source message.

The complex value of lines 714-720 includes the key “Person” and its value is the complex value shown in lines 716-720 which consists of key-value pair 716, key-value pair 718, and key-value pair 720. Key-value pair 716 consists of the key “Name” and its value is the source path to the data of the Name node from the source message. Key-value pair 718 consists of the key “Address” and its value is the source path to the data of the Address node from the source message. Key-value pair 720 consists of the key “Other” and its value is the source path of the data of the Country node from the source message.

Lines 724-734 are an example of joining disjoint sets of data to get a desired transformation result. The key “Trips” 722 has a complex value that consists of lines 724-734. The complex value of lines 724-734 consist of a “$for statement” that iterates for each entry of the Trips array of the source message. In the for statement at line 724, “$for(/ns0:Root/ns0:Looping/ns0:VehicleTrips:/ns0:Trip,$i),/ns0:Root/ns0:Looping/ns0:VehicleTrips:/ns0:Trip is the selector and $i is an optimal variable reference.

The corresponding value is another complex value that consists of lines 726-734. The complex value of lines 726-734 includes the key “Trip” and its corresponding value is the complex value shown in lines 728-734. The complex value of lines 728-734 includes a “$for statement” that iterates through each entry of the Vehicle array of the source message. The associated value is lines 728-734 which is a complex value consisting of an “$if statement” that controls execution of lines 730-734 based on the condition that the VehicleID of the Vehicle node and the VehiceID of the Trips node of the source message are equal. When the condition is satisfied, three key-value pairs are executed which includes setting the data of the VehicleRegistration node of the target message to the data of the VehicleRegistration node of the source message 730, setting the data of the Distance node of the target message to the data of the Distance node of the source message 732 and setting the data of the Duration node of the target message to the data of the Duration node of the source message 734.

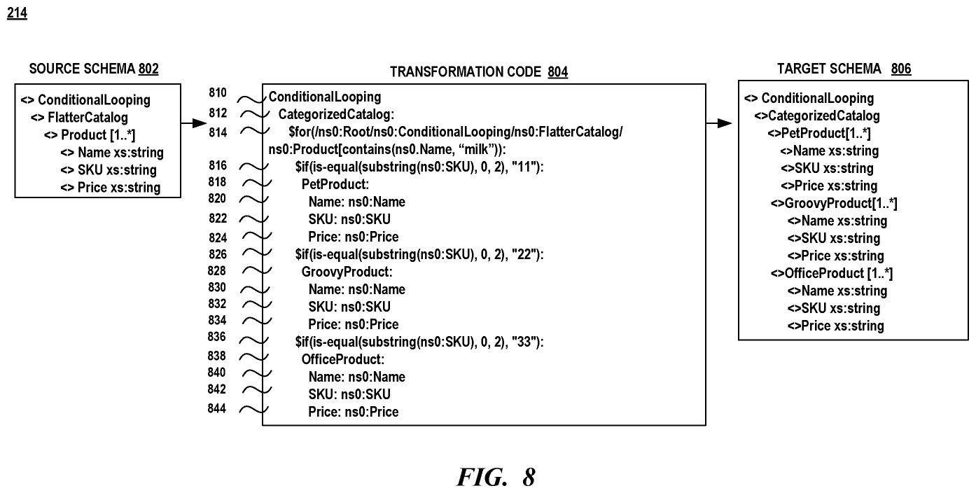

FIG. 8 illustrates an exemplary transformation 214 of a source schema 802 that is transformed into a target schema 806 using transformation code 804. In this transformation, a flattened schema is expanded using conditional looping where the body of a loop includes multiple if statements to expand the source schema into the expanded target schema.

The key “ConditionalLooping:” include a complex value consisting of lines 812-844. The complex value of lines 812-844 includes the key “CategorizedCatalog” and its corresponding value consists of lines 814-844. Line 814 consists of a “$for statement” having a filter to extract records that contain the Name “milk”. The “$for statement” is a key that iterates through its corresponding complex value of lines 816-844 for select records of the Product array of the source message that contain the value “milk” in the Name node. The filter specifies that only records in the Product array having the Name of “milk” are extracted and processed. The filter is shown in FIG. 8 as “/ns0:Product[contains (ns0:Name, “milk”)]”. The “$for statement” also includes a selector to the Product array of the source message which is/ns0:Root/ns0:ConditionalLooping/ns0:flatterCatalog”.

The complex value of lines 818-844 consists of three nested key-value pairs. The nested key-value pair of lines 818-826 consists of a “$if statement” of line 818 as a key with its corresponding value in lines 820-826. The “$if statement” 818 controls the execution of lines 820-826 based on a condition of certain bits in the data of the SKU node of the source message. The “$if statement” contains the is_equal function with an embedded substring function which checks if the first two characters of the SKU string, SKU, includes “11.’ When the condition is satisfied, lines 820-826 are executed where the Name, SKU, and Price nodes of the source message that correspond to the Name having the value “milk”, are extracted and input into the corresponding nodes of the PetProduct array of the target message.

The key-value pair of lines 826-834 consists of a “$if statement” in line 826 as a key with its corresponding value in lines 828-834. The “$if statement” 826 controls the execution of lines 828-834 based on a condition of certain bits in the data of the SKU node of the source message. The “$if statement” contains the is_equal function with an embedded substring function which checks if the first two characters of the SKU string include “22.’ When the condition is satisfied, lines 828-834 are executed where the Name, SKU, and Price nodes of the source message, where the data associated with the Name “milk”, are extracted and input into associated nodes of the GroovyProduct array of the target message.

The key-value pair of lines 838-844 consist of a “$if statement” in line 838 as a key with its corresponding value in lines 840-844. The “if statement” of line 838 controls the execution of lines 840-844 based on a condition of certain bits in the data of the SKU node of the source message containing the value “33.” Line 840 includes the key “OfficeProduct” and its associated value includes several nested key-value pairs in lines 840-844 which extract the data in the Name, SKU, and Price nodes of the source message corresponding to an Office Product into corresponding nodes of the OfficeProduct array of the target message.

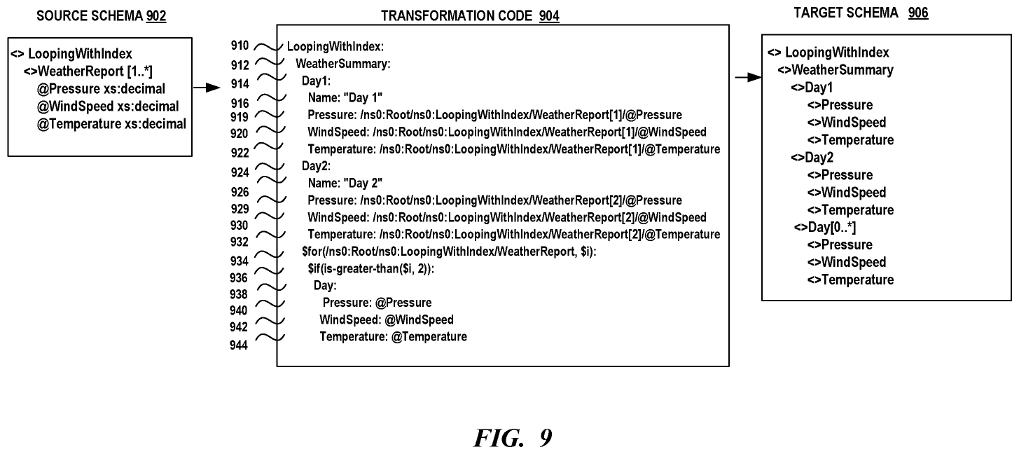

FIG. 9 illustrates an exemplary transformation 216 of a source schema 902 that is transformed into a target schema 906 using transformation code 904. The transformation code in FIG. 9 illustrates fixed indexing within a loop and variable indexing within a loop. This example also illustrates a qualifiedNodeName that uses the @ character to identify element and attribute names from an XML schema.

The transformation code 904 includes the key “Looping WithIndex:” 910 and its corresponding value is a complex value including lines 912-944 that includes several nested key-value pairs. Of particular interest is lines 919-922 which illustrate extracting data using a fixed index to obtain the Pressure, WindSpeed, Temperature data from the first entry of the WeatherReport array of the source message into corresponding nodes of the Day 1 node of the target schema. The expression of line 919 includes the key “Pressure” and its corresponding value is an expression that uses a fixed index into the WeatherReport array to extract the data of the XML element, @Pressure, from the first entry of the WeatherReport array. Likewise, the expression of line 920 includes the key “WindSpeed” and its corresponding value is an expression that uses a fixed index into the WeatherReport array to extract the XML element, @WindSpeed, for the first element of the WeatherReport array. Similarly, the expression of line 922 includes the key “Temperature” and its corresponding value is an expression that uses a fixed index into the WeatherReport array to extract the XML element, @Temperature, for the first element of the WeatherReport array.

Lines 924-930 perform similar operations as in lines 914-922 with respect to the second index into the WeatherReport array.

Lines 932-944 are an example of the use of looping with a variable index. Line 934 is for statement that loops through each entry of the WeatherReport array using the variable index, $i. Line 936 is an if statement that controls execution of the key-value pairs of lines 938-944 using the is-greater-than function to loop through entries of the WeatherReport array beyond the first two entries. The data from the Pressure, WindSpeed, and Temperature nodes of these entries of the WeatherReport array are extracted and input into corresponding entries of the Day array of the target schema.

It should be noted that although the transformations shown in FIGS. 2A-2C and in FIGS. 3-9 pertain to a transformation from an XML schema to a JSON schema, the techniques described herein apply to the conversion of any message format and schema to any other message format and schema including without limitation, a JSON schema to an XML schema, an XML schema into a different XML schema and a JSON schema into a different JSON schema. XML and JSON are exemplary message formats. The techniques described herein may be used with other message formats, such as Society for Worldwide Interbank Financial Telecommunications (SWIFT), RosettaNet, Electronic Data Interchange for Administration, Commerce, and Transportation (EDIFACT), American National Standards Institute (ANSI) X12, and Health Level Seven (HL7).

### Methods

Attention now turns to a more detailed description of the methods used in the system. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

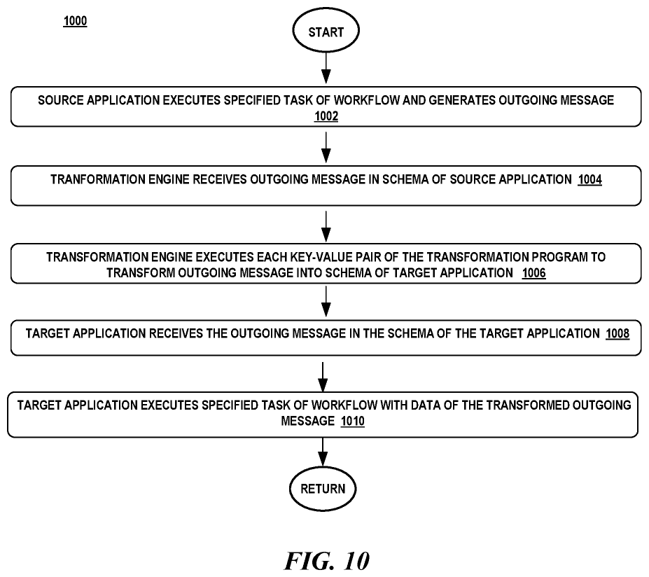

FIG. 10 illustrates an exemplary method 1000 of the message transformation process. In an enterprise integration system, a source application executes a task of a workflow producing an output message having data configured in a source message format and schema (block 1002). The transformation engine receives the output message in the source message format and schema (block 1004).

The transformation engine executes a message transformation program corresponding to the input message format ($input) and source schema ($sourceSchema) to transform the output message into an input message configured into the target message format ($output) and schema of the target application ($targetSchema) (block 1006). The transformation engine parses the output message and executes the operations of the key-value pairs thereby generating an output message in the target schema (block 1006).

The target application receives the input message in the target message format and schema (block 1008) and executes a task of the workflow using the data of the input message (block 1010).

### Exemplary Operating Environment

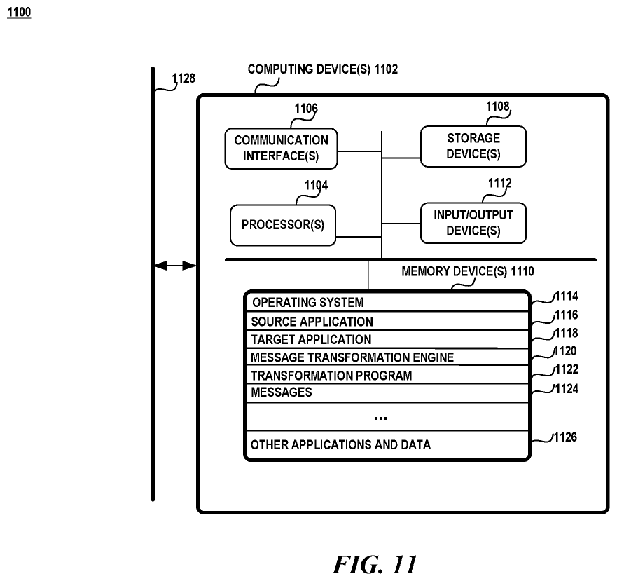

Attention now turns to a discussion of an exemplary operating environment 1100. FIG. 11 illustrates an exemplary operating environment 1100 in which one or more client computing devices 1102 communicate with one or more computing devices in an enterprise integration system. However, it should be noted that the aspects disclosed herein is not constrained to any particular configuration of the computing devices.

A computing device 1102 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 400 may be configured in a network environment, a distributed environment, a multi-processor environment, or a stand-alone computing device having access to remote or local storage devices.

A computing device 1102 may include one or more processors 1104, one or more communication interfaces 1106, one or more storage devices 1108, one or more memory devices or memories 1110, and one or more input/output devices 1112. A processor 1104 may be any commercially available or customized processor and may include dual microprocessors and multi-processor architectures. A communication interface 1106 facilitates wired or wireless communications between the computing devices and with other devices. A storage device 1108 may be computer-readable medium that does not contain propagating signals, such as modulated data signals transmitted through a carrier wave. Examples of a storage device 1108 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1108 in a computing device 1102. The input/output devices 1112 may include a keyboard, mouse, pen, voice input device, touch input device, display, speakers, printers, etc., and any combination thereof.

A memory device or memory 1110 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 1110 may also include one or more external storage devices or remotely located storage devices that do not pertain to propagated signals, such as modulated data signals transmitted through a carrier wave.

A memory device 1110 may contain instructions, components, and data. A component is a software program that performs a specific function and is otherwise known as a module, program, and/or application. Memory device 1110 may include an operating system 1114, a source application 1116, a target application 1118, a transformation program 1120, messages 1122 and other applications and data 1124.

The computing devices 1102 may be communicatively coupled via a network 1128. The network 1128 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 1128 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect/Technical Improvement

Aspects of the subject matter disclosed herein pertain to the technical problem of transforming messages configured in different message formats and schemas within a workflow of an enterprise integration system. The technical features associated with addressing this problem are the program constructs of the key-value pairs which provide enhanced capabilities that are performed on a computer without additional computational burden. The technical effect achieved is the ability to transform any message in any message format and schema into any other message format and schema directly without an intermediate transformation.

In one or more embodiments, the enterprise integration system operates in a high-volume environment where millions or more messages go through the system daily. The transmission of the messages from a source to a recipient is expected to be performed rapidly in order to timely complete a workflow. In order to operate at this high volume within the tight timing constraints, the transformations performed by the transformation engine need to be performed on a computing device. The operations performed by the key-value pairs are inherently digital. A human mind cannot interface directly with a CPU, or network interface card, or other processor, or with RAM or digital storage, to read and write the necessary data and perform the necessary transformations and other data processing steps taught herein. Embodiments are also presumed to be capable of operating at scale in production environments or in testing labs for production environments as opposed to being mere thought experiments.

The technique described herein is a technical improvement over prior solutions that were limited to transforming schemas of a same message format, such as an XML schema into a different XML schema or which performed transformations using an intermediate message format. The program constructs used in the key-value pairs, such as the control flow statements, selectors, filters, indices, and expressions enhance the computer's ability to perform transformations between different types of schemas of different message formats expeditiously to meet the demands of an enterprise integration system.

### CONCLUSION

A computer-implemented method for transforming data of a message transmitted between a source application and a target application within an enterprise integration system, is disclosed comprising: receiving a first message from the source application, wherein the first message includes a payload having a plurality of nodes structured with a first message format in a first data schema, wherein the first message format and first data schema differs from a second message format and second data schema of the target application; executing a transformation program to transform the first message into a second message having the second message format and second data schema, wherein the transformation program comprises a plurality of key-value pairs, wherein each of the plurality of key-value pairs include instructions to directly map data of the first message into a target node of the second schema without an intermediate transformation, wherein a key of a key-value pair includes a target node of the second schema, wherein a value of the key-value pair includes an expression that produces a value for the target node of the second message using data in the first message; and transmitting the second message to the target application.

In an aspect, the expression includes a selector to access the data of the first message. In an aspect, the expression includes a nested expression having a first expression embedded into a second expression. In an aspect, the expression includes a function that operates on the data of the first message to produce the value for the target node of the second message. In an aspect, the function includes a selector to access the data of the first message. In an aspect, the transformation program includes a second key-value pair having a second key and a second value, wherein the second key includes a target node of the second schema, the second value includes a selector that extracts data from the first message. In an aspect, the first schema is associated with an Extensible Markup Language (XML) schema or a JavaScript Object Notation (JSON) schema and the second schema is associated with an Extensible Markup Language (XML) schema or a JavaScript Object Notation (JSON) schema.

An enterprise integration system is disclosed comprising: a processor; and a memory that stores a program configured to be executed by the processor. The program including instructions to transform data of a message transmitted from a source application to a target application by performing actions that: receive a source message from the source application, wherein the source message includes a plurality of data configured in a first message format and first schema; execute each of a plurality of key-value pairs of a transformation program to generate a target message structured in a second schema from data of the source message, wherein each of the plurality of key-value pairs directly maps data of the source message into a target node of a source message without an intermediate transformation, wherein a first key of a first key-value pair of the plurality of key-value pairs includes a for statement that iterates through an array of data of the source message, wherein a first value of the first key-value pair includes an expression that produces data for the target node of th target message from the array of data of the source message; and transmit the target message to the target application.

In an aspect, the for statement includes a selector to access the array of data of the source message. In an aspect, the for statement includes a filter that iterates through select data of the array of data of the source message. In an aspect, the for statement includes a variable index. In an aspect, the expression includes additional key-value pairs, wherein each of the additional key-value pairs includes a key that represents a target node and a value that includes a selector or an expression, wherein the selector accesses data from the first message, wherein the expression executes operations to generate data from the first message for a corresponding target node.

In an aspect, the expression includes a function that includes nested functions, wherein each nested function performs an operation on select data of the source message. In an aspect, wherein the first schema is associated with an Extensible Markup Language (XML) schema or a JavaScript Object Notation (JSON) schema and the second schema is associated with an Extensible Markup Language (XML) schema or a JavaScript Object Notation (JSON) schema. In an aspect, the first schema and the second schema differ.

One or more hardware storage devices are disclosed having stored thereon computer executable instructions that are structured to be executable by one or more processors of a computing device to thereby cause the computing device to transform data of a message transmitted from a source application to a target application in an enterprise integration system by performing actions that: receive a source message from the source application, wherein the source message includes a plurality of data configured in a first message format and first schema; execute each of a plurality of key-value pairs of a transformation program to generate a target message structured in a second message format and second schema from data of the source message, wherein each of the plurality of key-value pairs directly maps data of the source message into a target node of the target message without an intermediate transformation, wherein a first key of a first key-value pair of the plurality of key-value pairs includes an if statement that executes one or more additional key-value pairs based on a condition being met, wherein the first value of the first key-value pair includes an expression that produces data for an intended target node of the second schema from data of the source message; and transmit the target message to the target application.

In an aspect, the condition of the if statement is based on data of the source message being met. In an aspect, the if statement contains a selector that accesses particular data from the source message to determine if the condition is met. In an aspect, the if statement contains a function that operates on select data from the source message to determine if the condition is met. In an aspect, the if statement contains nested functions to determine if the condition is met.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for transforming data of a message transmitted between a source application and a target application within an enterprise integration system, comprising:
receiving a first message from the source application, wherein the first message includes a payload having a plurality of nodes structured with a first message format in a first data schema, wherein the first message format and first data schema differs from a second message format and second data schema of the target application;
executing a transformation program to transform the first message into a second message having the second message format and second data schema, wherein the transformation program comprises a plurality of key-value pairs, wherein each of the plurality of key-value pairs include instructions to directly map data of the first message into a target node of the second schema without an intermediate transformation, wherein a key of a key-value pair includes a target node of the second schema, wherein a value of the key-value pair includes an expression that produces a value for the target node of the second message using data in the first message; and
transmitting the second message to the target application.

2. The computer-implemented method of claim 1, wherein the expression includes a selector to access the data of the first message.

3. The computer-implemented method of claim 1, wherein the expression includes a nested expression having a first expression embedded into a second expression.

4. The computer-implemented method of claim 1, wherein the expression includes a function that operates on the data of the first message to produce the value for the target node of the second message.

5. The computer-implemented method of claim 4, wherein the function includes a selector to access the data of the first message.

6. The computer-implemented method of claim 1, wherein the transformation program includes a second key-value pair having a second key and a second value, wherein the second key includes a target node of the second schema, the second value includes a selector that extracts data from the first message.

7. The computer-implemented method of claim 1, wherein the first schema is associated with an Extensible Markup Language (XML) schema or a JavaScript Object Notation (JSON) schema and the second schema is associated with an Extensible Markup Language (XML) schema or a JavaScript Object Notation (JSON) schema.

8. An enterprise integration system comprising:
a processor; and
a memory that stores a program configured to be executed by the processor, the program including instructions to transform data of a message transmitted from a source application to a target application by performing actions that:
receive a source message from the source application, wherein the source message includes a plurality of data configured in a first message format and first schema;
execute each of a plurality of key-value pairs of a transformation program to generate a target message structured in a second schema from data of the source message,
wherein each of the plurality of key-value pairs directly maps data of the source message into a target node of a source message without an intermediate transformation,
wherein a first key of a first key-value pair of the plurality of key-value pairs includes a for statement that iterates through an array of data of the source message, wherein a first value of the first key-value pair includes an expression that produces data for the target node of th target message from the array of data of the source message; and
transmit the target message to the target application.

9. The system of claim 8, wherein the for statement includes a selector to access the array of data of the source message.

10. The system of claim 8, wherein the for statement includes a filter that iterates through select data of the array of data of the source message.

11. The system of claim 8, wherein the for statement includes a variable index.

12. The system of claim 8, wherein the expression includes additional key-value pairs, wherein each of the additional key-value pairs includes a key that represents a target node and a value that includes a selector or an expression, wherein the selector accesses data from the first message, wherein the expression executes operations to generate data from the first message for a corresponding target node.

13. The system of claim 12, wherein the expression includes a function that includes nested functions, wherein each nested function performs an operation on select data of the source message.

14. The system of claim 8, wherein the first schema is associated with an Extensible Markup Language (XML) schema or a JavaScript Object Notation (JSON) schema and the second schema is associated with an Extensible Markup Language (XML) schema or a JavaScript Object Notation (JSON) schema.

15. The system of claim 8, wherein the first schema and the second schema differ.

16. One or more hardware storage devices having stored thereon computer executable instructions that are structured to be executable by one or more processors of a computing device to thereby cause the computing device to transform data of a message transmitted from a source application to a target application in an enterprise integration system by performing actions that:
receive a source message from the source application, wherein the source message includes a plurality of data configured in a first message format and first schema;
execute each of a plurality of key-value pairs of a transformation program to generate a target message structured in a second message format and second schema from data of the source message,
wherein each of the plurality of key-value pairs directly maps data of the source message into a target node of the target message without an intermediate transformation,
wherein a first key of a first key-value pair of the plurality of key-value pairs includes an if statement that executes one or more additional key-value pairs based on a condition being met, wherein the first value of the first key-value pair includes an expression that produces data for an intended target node of the second schema from data of the source message; and
transmit the target message to the target application.

17. The one or more hardware devices of claim 16, wherein the condition of the if statement is based on data of the source message being met.

18. The one or more hardware devices of claim 16, wherein the if statement contains a selector that accesses particular data from the source message to determine if the condition is met.

19. The one or more hardware devices of claim 16, wherein the if statement contains a function that operates on select data from the source message to determine if the condition is met.

20. The one or more hardware devices of claim 16, wherein the if statement contains nested functions to determine if the condition is met.
